(19) United States
(12) Patent Application Publication
(10) Pub. No.: US 2015/0220927 A1
(43) Pub. Date: Aug. 6, 2015

(54) METHOD, APPARATUS AND SYSTEM FOR PROVIDING TRANSACTION INDEMNIFICATION

(71) Applicants: Ned M. SMITH, Hillsboro, OR (US); Thomas J. SAWICKI, Hillsboro, OR (US); Rajiv MATHUR, Santa Clara, CA (US); Tolga ACAR, Sammamish, WA (US); Yuriy BULYGIN, Beaverton, OR (US); Thomas G. WILLIS, Portland, OR (US); Intel Corporation, Santa Clara, CA (US)

(72) Inventors: Ned M. Smith, Hillsboro, OR (US); Thomas J. Sawicki, Lake Oswego, OR (US); Rajiv Mathur, Saratoga, CA (US); Tolga Acar, Sammamish, WA (US); Yuriy Bulygin, Beaverton, OR (US); Thomas G. Willis, Portland, OR (US)

(21) Appl. No.: 14/129,543

(22) PCT Filed: Sep. 25, 2013
(86) PCT No.: PCT/US2013/061763

§ 371 Date: Dec. 26, 2013

(51) Int. Cl. G06Q 20/40; H04L 29/08

(52) U.S. Cl. CPC G06Q 20/4016; H04L 67/10

(57) ABSTRACT

Techniques and mechanisms to provide indemnification for a transaction involving communications between networked devices. In an embodiment, attestation logic of a first device sends to a second device attestation information to indicate a trustworthiness level of first device. Based on the attestation information, indemnification logic of the second device determines an indemnification value representing a cost of an indemnification for a first transaction. Indemnification logic of the first device receives the indemnification value and determines, based on the indemnification value, whether a participation in the transaction is to take place.

### BACKGROUND

1. Technical Field

Embodiments discussed herein relate generally to network communications, and more particularly (but not exclusively), to indemnifying a commercial transaction involving networked devices.

2. Background Art

Many existing architectures for computer networking are easily susceptible to attack by STUXNET or other such malware, which pose threats to mission-critical operations and infrastructures. Coincidental with these threats is the continued integration of networking functionality into increasingly numerous and varied types of devices. Such integration is evidenced by technological advances toward is referred to as an “Internet-of-things.”

As more and more types of devices become capable of networking with one another, the distinctions between various types of networks (e.g. control, transaction, data and/or the like) continue to blur. Already, the distinction between “network” and “computation” networks are increasingly becoming indistinguishable, leading to new naming conventions such as “cloud” and “mesh” computing paradigms. One adverse result is that many traditional techniques for protecting business enterprise transactions are failing. This is particularly the case in various automated applications, where industry practice is for vendors to disclaim liability and where insurance underwriters have failed to implement mechanisms to offer indemnification for errant network or computer system behavior.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating elements of a system for providing transaction indemnification according to an embodiment.

FIG. 2 is a block diagram illustrating elements of a hierarchical network for disseminating attestation information according to an embodiment.

FIG. 3 is a block diagram illustrating elements of a computer platform to participate in an indemnified transaction according to an embodiment.

FIG. 4 is a flow diagram illustrating elements of a method for indemnifying a transaction between network nodes according to an embodiment.

FIG. 5 is a block diagram illustrating elements of a device for exchanging indemnification information according to an embodiment.

FIG. 6 is a block diagram illustrating elements of a device for exchanging indemnification information according to an embodiment.

### DETAILED DESCRIPTION

Embodiments discussed herein variously provide techniques and/or mechanisms for offering indemnification for a transaction which is conducted between networked devices. In an embodiment, a first entity (e.g. a computing hardware and/or software environment) considered participating in a transaction involving a second entity, where the second entity is unfamiliar to the first entity. There is risk that the transaction might not be performed as expected, in one or more respects. For example, one or each of the entities may perceive risk in the opposing entity's environment. Either or each entity may seek risk mitigation in the form of an insurer entity (or agent thereof) who underwrites the transaction.

Accordingly, in an embodiment, one or more devices of the network may each include respective logic operate at various times in what is referred to herein as a “sensor” capacity and/or to operate at various times in what is referred to herein as a “controller” capacity. A sensor may determine and/or communicate information describing a sensed capability, state or other characteristic of the device or network. For example, sensor logic may serve to sense, and generate information attesting to—a current level of trustworthiness of the device in which it resides, another device coupled to that device, a portion of the network coupling the two devices, and/or the like. Alternatively or in addition, controller logic may receive and process such information—referred to herein as attestation information—to produce an output for implementing a transaction indemnification. Such a network may be made trustworthy when sensors and controllers connect to include respective trusted resources which variously communicate with one another via trusted paths.

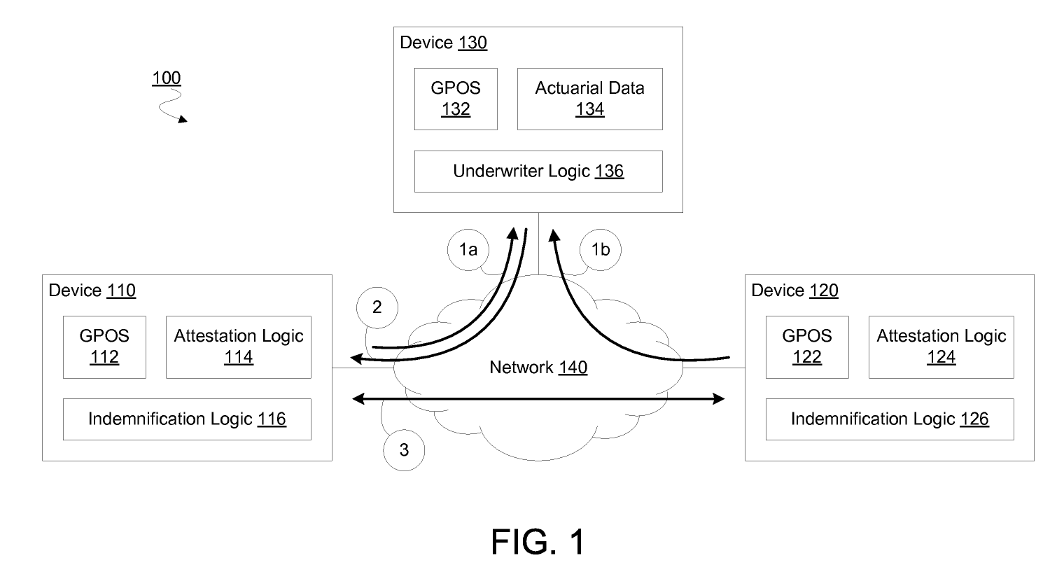

FIG. 1 illustrates elements of a system 100 for providing transaction indemnification according to an embodiment. System 100 may comprise a network of devices, one or more of which include respective trusted resources for exchanging attestation information and/or indemnification information which is based on an exchange of such attestation information. For example, system 100 may include devices 110, 120, 130 which are networked with one another—e.g. via an illustrative network 140. Network 140 may comprise a Wide Area Network (WAN), such as the Internet, a Metropolitan Area Network (MAN), a Local Area Network (LAN), a wired or wireless data network, or any other suitable network or combination of network types. In one embodiment, some or all of devices 110, 120, 130 are part of a mesh network. Alternatively or in addition, devices 110, 120, 130 may be coupled together in a network which is hierarchical—e.g. at least with respect to the configuration of attestation/indemnification functionality discussed herein. Typically, at least part of network 140 is public.

In an embodiment, one or more of devices 110, 120, 130 each include a respective computer or other electronic device including logic to participate in a commercial (or other) transaction. By way of illustration and not limitation, devices 110, 120, 130 may each comprise a respective one of a server, personal computer (e.g. desktop, laptop, notebook, etc.), handheld device (e.g. smartphone, palmtop, tablet), point-of-sale device, smart television, set-top box, gaming console or other such device suitable for participating in a transaction with another electronic device. Typically, devices 110, 120, 130 comprise respective general-purpose processors which are variously programmed in software to carry out various functions. The software may be downloaded to the processors in electronic form, over a network, for example, or it may, alternatively or additionally, be provided and/or stored on tangible media, such as magnetic, optical, or electronic memory.

Features of certain embodiments are discussed herein with respect to a scenario wherein device 110 makes a commercial service available through network 140, where device 120 is, or is operated on behalf of, a customer agent which is to avail of that commercial service. In this illustrative scenario, device 130 is to offer (and in an embodiment, provide) an underwriting to indemnify one or more clients—e.g. including a commercial entity, a customer thereof, or both—if the transaction should fail in some respect. However, such discussion may be extended to additionally or alternatively apply to any of a variety of other transactional and/or indemnification scenarios, in different embodiments. For example, some or all of devices 110, 120, 130 may variously serve at different times as transaction underwriters (or agents thereof) for one another.

Device 110 may correspond to an e-commerce web-site, a computer system of a financial institution or other organization, a database server and/or any other suitable computing platform that interacts with users or clients. Users of such services may comprise, for example, customers, suppliers, employees or partners of an organization. For example, device 110 may make various services available to device 120, depending on the specific commercial (or other) application. At some point in time, hardware and/or software of device 110 may operate to perform an evaluation of whether participation in a particular transaction is to take place—e.g. participation in the illustrative transaction 3 with device 120.

In many applications, it is important for device 110 to evaluate a risk of participating in a transaction which also involves device 120. For example, it may be important to quantify a risk that, for example, device 120 is infected by a virus, an impersonation attack or other security risk. For this purpose, system 100 may provide one or more devices—represented by the illustrative device 130—to serve as a source of indemnification information which quantifies such risk. The quantification may be specific to only a particular transaction—e.g. based on a calculated probability of failure of the transaction and/or a value of the transaction.

By way of illustration and not limitation, an exchange 1a may provide device 130 with attestation information from device 110, the attestation information indicating a level of trustworthiness of device 110. In an embodiment, the attestation information provided in exchange 1a is generated by attestation logic 114 of device 110. Attestation logic 114 may comprise hardware and/or software to access data programmed during fabrication, assembly or initial configuration of one or more components of device 110. Alternatively, attestation logic 114 may generate or otherwise access data resulting from runtime operation of device 110. Attestation logic 114 may provide some functionality which, for example, is adapted from conventional attestation mechanisms and/or techniques.

In an embodiment, attestation information from attestation logic 114 describes or otherwise indicates an ability of device 110 to provide security mechanisms including, but not limited to, one or more of authentication, authorization, cryptography, hardware isolation, software isolation and/or the like. Attestation information may indicate performance characteristics of device 110 including, but not limited to, one or more of a processing power, a storage capacity, a virus detection/protection capability, a quality of service, a communication rate, a load balancing functionality and/or the like. Alternatively or in addition, attestation information may indicate a current or otherwise most recent state of device 110, including, but not limited to, one or more of a virus scan result, a data integrity scan result and/or the like. Alternatively or in addition, attestation information may include one or more types of contextual data collected by one or more sensor devices. Such contextual data may specify or otherwise indicate physical and/or environmental conditions of a sensor device such as a physical location, a relative location or proximity to one or more other physical objects (e.g. including one or more people and/or other devices), atmospheric changes, motion and other context as may be established by any of various environment sensor technologies.

System 100 may provide for the exchange of other attestation logic—e.g. in addition to that of exchange 1a. For example, an exchange 1b may provide device 130 with other attestation information indicating a level of trustworthiness of device 120. The attestation information provided in exchange 1b may be generated by attestation logic 124 of device 120—e.g. where attestation logic 124 provides functionality corresponding to some or all of that provided by attestation logic 114. For example, attestation information provided in exchange 1b may describe or otherwise indicate with respect to device 120 some or all of the types of information which exchange 1a may indicate with respect to device 110. Alternatively or in addition, one or more other exchanges (not shown) may provide to either or both of devices 110, 120 attestation information indicating a level or trustworthiness of device 130. Any of a variety of additional or alternative exchanges of attestation information may be supported in system 100. In an embodiment, one or more network nodes of system 100 maintain data to be made available for evaluating risk of one or more transactions involving a node or nodes of system 100. By way of illustration and not limitation, device 130 may include memory to store actuarial data 134 which includes, or is otherwise based on, attestation information received by device 130. For example, portions of actuarial data 134 may be based on respective attestation information in exchanges 1a, 1b.

Some or all of actuarial data 134 may be stored in memory (e.g. random access memory) of device 130 by underwriter logic 136, for example. In an embodiment, such storing is performed by attestation logic (not shown) of device 130 which is included in or coupled to underwriter logic 136. Actuarial data 134 may include one or more data structures (e.g. including a file, table, record, linked list and/or the like) which comprise elements corresponding to respective network nodes of system 110. Such elements may include respective values—referred to herein as “strength-of-function” values, or simply “strength” values—which each represent a metric of a respective network nodes' ability to mitigate transactional risk.

In addition to attestation information from a network node, a strength value may, in certain embodiments, be further based on information describing one or more network characteristics which are external to that network node. For example, as discussed herein, actuarial data 134 may include a strength value calculated at device 130 based on both attestation information in exchange 1a and a complexity metric, path metric and/or other metric which is descriptive of network elements outside of device 110. Such a metric may describe, for example, a percentage of past transactions involving the network elements which were successfully (or unsuccessful).

At some point in time, device 130 may access actuarial data 134 to determine a level of indemnification to offer for a transaction under consideration. By way of illustration and not limitation, underwriter logic 136 may receive an indication that such a transaction is under consideration. The indication may include one or more of exchange 1a, exchange 1b or some other message (not shown) sent to request from device 130 a cost for and/or level of indemnification for transaction 3. Alternatively, the indication may include a communication which is intercepted, snooped or otherwise detected by device 130, the communication sent to facilitate performance of the transaction. In one embodiment, one or both of exchanges 1a, 1b are performed in response to device 130 detecting that a transaction is under consideration. In another embodiment, one or both of exchanges 1a, 1b are performed in advance of such detection—e.g. where actuarial data 134 is available in advance of such detection for determining an indemnification value for the detected transaction.

For example, based on an indication of a transaction 3, underwriter logic 136 may automatically determine an indemnification value representing a cost of an indemnification for transaction 3. The indemnification value may be calculated, for example, based on attestation information provided in exchange 1a, attestation information provided in exchange 1b, or both. Calculation of such an indemnification value may be additionally or alternatively based on information describing, for example network nodes and/or paths of system 100. In an embodiment, calculating an indemnification value includes calculating a probability value describing a likelihood of a failure associated with transaction 3. Alternatively or in addition, calculating an indemnification value may include calculating a value of transaction 3—e.g. in terms of money, resources, time, services or other consideration expected to be exchanged as part of transaction 3.

In response to detecting transaction 3, underwriter logic 136 may output the determined indemnification value for transaction 3 for communication to device 100—e.g. in an illustrative exchange 2. Alternatively or in addition, device 130 may perform an exchange (not shown) to provide to device 120 the same indemnification value, or a different indemnification value, for the same transaction 3. In another embodiment, devices 110, 120 receive respective indemnification values for transaction 3 each from a different device of system 100.

In an embodiment, device 110 includes indemnification logic 116 to receive the indemnification value in exchange 2 and to determine, based on the indemnification value, whether participation in a transaction is to take place—e.g. whether device 110 (or some other device) is to participate in the transaction 3. Although certain embodiments are not limited in this regard, device 120 may comprise indemnification logic 126 to receive the same or another indemnification value and to determine, based on such an indemnification value, whether device 120 (or some other device) is to participate in the transaction 3. Evaluation of whether to participate in transaction 3 may be adapted from any of a variety of conventional cost-benefit analysis techniques. For example, such techniques may be adapted to compare, for example, a cost of having transaction 3 indemnified with an a priori threshold value. The particular details of such conventional cost-benefit analysis techniques are not limiting on certain embodiments, and are not detailed herein.

In an embodiment, some or all network nodes of system 100 include respective resources which are recognized among such nodes as being trusted—e.g. at least insofar as access to such trusted resources is restricted in one or more respects. For example, resources of a network node may be recognized as trusted by other nodes, where an operating system (or other relatively less secure resource) of that network node is restricted from some access to the trusted resources. Such trusted resources may include logic for the network node to determine and/or exchange one or both of attestation information and indemnification information.

By way of illustration and not limitation, devices 110, 120, 130 may variously comprise processing logic each to execute a general purpose operating system (GPOS), as illustrated by the respective GPOSs 112, 122, 132. Hardware and/or software mechanisms of device 110 may restrict GPOS 112 from access to attestation logic 114 and/or access to indemnification logic 116. Alternatively or in addition, hardware and/or software mechanisms of device 120 may restrict GPOS 122 from access to attestation logic 124 and/or access to indemnification logic 126. Alternatively or in addition, hardware and/or software mechanisms of device 130 may restrict GPOS 132 from access to one or both of actuarial data 134 and underwriter logic 136 (and/or, in an embodiment, attestation logic—not shown—of device 130).

Such hardware and/or software mechanisms may include processor hardware, memory regions, signal paths, processing cycles or the like being at least partially isolated or otherwise dedicated for attestation or indemnification operations. For example, trusted resources may include circuitry for a trusted execution environment, a trusted platform module, a hardware security module, a security management mode of software execution and/or the like. Examples of technologies for variously implementing one or more TEEs to be adapted according to various embodiments include, but are not limited to, Intel® SGX (Software Guard eXtensions), Intel® Converged Security Engine (CSE) and Intel® Manageability Engine (ME). Various ones of these technologies also include or otherwise support corresponding attestation architectures or mechanisms. Accordingly, some or all of GPOSs 112, 122, 132 may each be restricted from accessing resources of their respective devices which are to variously determine and/or communicate attestation information, indemnification information, or both.

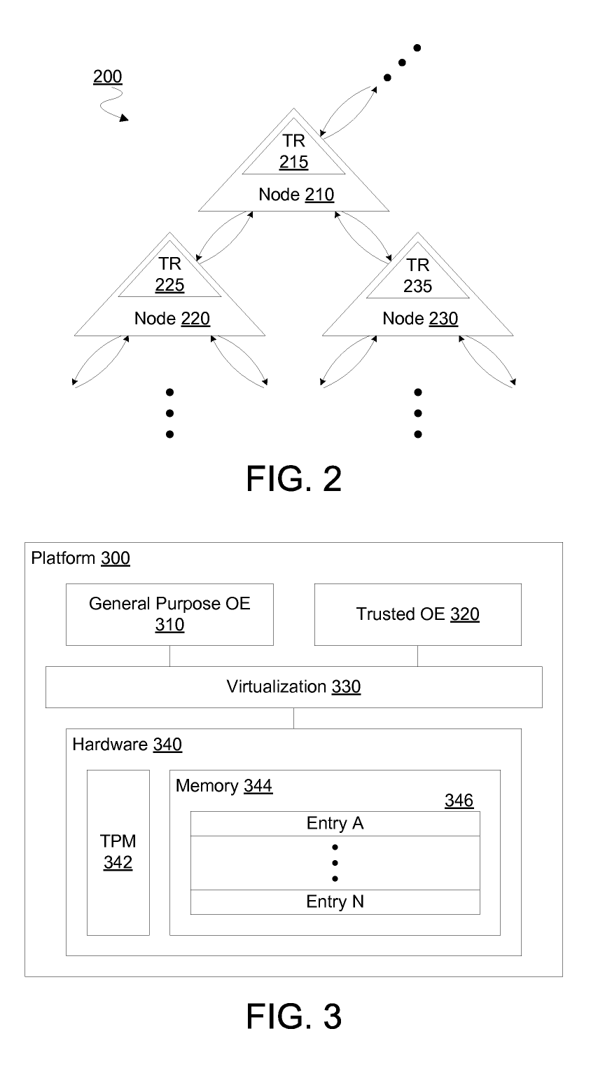

FIG. 2 illustrates elements of a network 200 for indemnifying a transaction according to an embodiment. Network 200 may include some or all of the features of system 100, for example. In an embodiment, network 200 comprises a plurality of nodes—e.g. including the illustrative nodes 210, 220, 230—to variously support communication of attestation information and/or indemnification information based on such attestation information. Some or all of nodes 210, 220, 230 may variously provide functionality such as that discussed herein with respect to devices 110, 120, 130, for example.

In an embodiment, network 200 comprises a contextual mesh network topology wherein inter-node communication is hierarchical in the context of exchanging attestation information and/or indemnification information, but may be more strongly interconnected in other respects—in the context of nodes being networked for participation in a transaction which is indemnified according to techniques discussed herein.

Alternatively or in addition, network 200 may comprise trusted nodes interconnected by trusted paths—e.g. where a property of the trusted nodes is some relative immutability of their respective trusted resources. By way of illustration and not limitation, nodes 210, 220, 230 may include respective trusted resources (TR) 215, 225, 235 which are recognized among such nodes as being trusted to perform operations to determine and/or communicate either or both of attestation information and indemnification information. The trusted resources 215, 225, 235 may variously implement strength-of-function scoring to generate actuarial data having some or all of the features of actuarial data 134, for example. Based on such strength-of-function scoring, a first node may indicate to a second node a level of risk associated with participation in a particular transaction. For example, the first node may indicate a cost for indemnifying the transaction.

In an embodiment, nodes of network 200 regularly exchange attestation information (and/or associated strength values or other actuarial data) among one another to maintain updated actuarial information across some or all of network 200. For example, a particular sub-network of network 200 may be configured to regularly disseminate actuarial data among all network nodes of that sub-network. A topology of network 200 may facilitate continuous or otherwise regular re-evaluation of some or all strength-of-function scoring so that actuarial data is current and available at least across some sub-network of network 200—e.g. regardless of which node or set of nodes of network 200 is to participate in some next transaction. For example, nodes 210, 220, 230 may be arranged in a hierarchy—e.g. at least with respect to configuration of such nodes to support transaction indemnification.

In an illustrative embodiment, node 220 may maintain actuarial data for a set of nodes which are underneath node 220 in the hierarchy, while node 230 instead maintains actuarial data for a different set of nodes which are underneath node 230 in the hierarchy. Node 210 may maintain actuarial data for both such sets of nodes, or neither set of nodes, in various embodiments. The maintaining of such actuarial data may facilitate the retrieval of a current strength-of-function value for a network node without having to access that network node or otherwise traverse a comparatively large number of nodes for such retrieval.

Before a given transaction proceeds, trust factors from each of multiple nodes in network 200 may be shared at least with a node which is to serve as, or operate on behalf of, and underwriter for the transaction. Based on such trust factors, one or more nodes of network 200 may calculate, communicate or otherwise determine respective strength scores for the multiple nodes and/or for one or more other elements of network 200. In an embodiment, trusted circuitry of a node may implement a mathematical formula to reduce a plurality of such strength scores to a single value—e.g. representing a trustworthiness factor for a particular transaction. For example, indemnification information representing a transaction-specific insurance policy may be automatically generated and communicated to at least one node which is a potential participant in the transaction (or agent for such a participant).

The potential participant node (or agent thereof) may evaluate the indemnification information and determine whether to participate in the transaction and/or whether to request indemnification for the transaction. Where the indemnification is requested, an underwriter agent may return a policy identifier which, for example, may be a condition of the transaction so both parties know the transaction is underwritten. When the transaction completes, the policy ID may be forwarded to the underwriter agent indicating termination of the policy. The underwriter agent may specify terms of expiry if transaction completion is not received.

If a failure associated with the transaction is detected—e.g. if the transaction doesn't complete in the way anticipated by one of the other users and/or if it is later determined that the transaction was performed based on fraudulent or otherwise incorrect information—a claim against the policy may be made by a participant node. An underwriter agent may evaluate entailment information associated with the transaction to ensure that processing for the transaction occurred within the relevant attested environments. Where such evaluation indicates conformity with policy terms, the underwriter agent may signal that the claim against the policy is to be allowed.

FIG. 3 illustrates elements of a platform 300 for exchanging indemnification information according to an embodiment. Platform 300 may comprise a hardware platform of an electronic device having some or all of the functionality of device 110 (or device 120), for example. Alternatively or in addition, platform 300 may provide some or all of the functionality of device 130. In an embodiment, platform 300 includes logic to exchange indemnification information in a network such as network 200 or that of system 100.

For example, platform 300 may comprise hardware 340, typically comprising one or more Central Processing Unit (CPU) devices, memory devices and any other suitable components or subsystems normally found in computing platforms. In particular, hardware 340 may comprise a memory 344 for storing attestation data and/or indemnification data. In an illustrative embodiment, memory 344 stores a table 346 comprising entries A, . . . , N each corresponding to a different respective network node (not shown) coupled to platform 300. At a given time, entries A, . . . , N may variously store updated strength-of-function scores each for a corresponding network node. Such strength-of function scores may be calculated with one or more trusted resources of platform 300—e.g. based on attestation information which the trusted resources receive from network nodes coupled to platform 300. Such trusted resources may access one or more strength-of-function scores from table 346 to calculate an indemnification value indicating a cost of indemnifying a transaction.

Platform 300 illustrates examples of trusted resources for exchanging indemnification information according to various embodiments. By way of illustration and not limitation, platform 300 may comprises a Trusted Platform Module (TPM) 342. The TPM 342 typically comprises a hardware device that is capable of generating machine-specific cryptographic keys or other secure information for authenticating the computer in which it is installed. TPMs are specified, for example, by the Trusted Computing Group (TCG) in TCG TPM Specification Version 1.3, Revision 103, Jul. 9, 2007. The role of TPM 342 may be to indicate a trustworthiness of platform 300 to one or more other nodes in a network, as described herein.

In some embodiments (although not necessarily), platform 300 runs two operating environments in parallel. In these embodiments, a General-Purpose Operating Environment (GPOE) 310 may run one or more applications other than an attestation application for platform 300 to communicate attestation information via a network and/or an indemnification application for platform 300 to generate or otherwise process information describing a policy for indemnifying a transaction.

In addition to GPOE 310, a Trusted Operating Environment (TOE) 320 may be configured expressly for communicating such attestation information. In an embodiment, access to TOE 320 by GPOE 310 is restricted—e.g. where software and/or hardware mechanisms decouple, or isolate, GPOE 310 and TOE 320 from one another in one or more respects. For example, the behavior, configuration and performance of GPOE 310 may have little or no effect on the behavior, configuration and performance of TOE 320.

Although certain embodiments are not limited in this regard, platform 300 may additionally or alternatively comprises a virtualization layer 330, which allocates hardware resources and other resources of platform 300 to GPOE 310 and TOE 320. Any suitable virtualization means, which may be implemented in hardware and/or software, can be used for this purpose. In some embodiments, GPOE 310 and TOE 320 run on separate “virtual CPUs” managed by the virtualization layer.

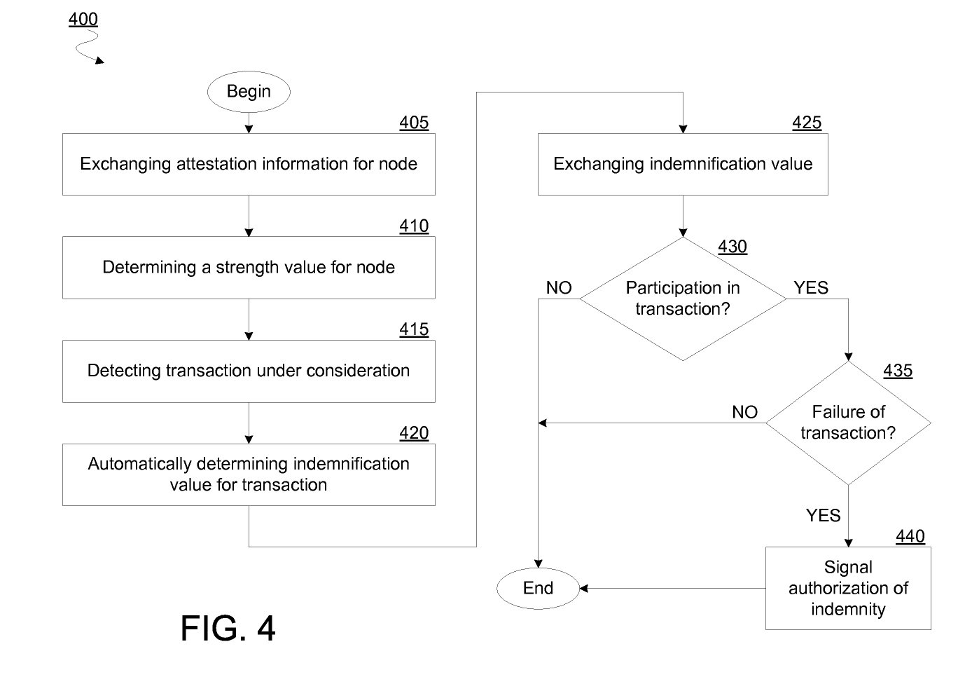

FIG. 4 illustrates elements of a method 400 for providing indemnification of a transaction according to an embodiment. Some or all operations of method 400 may be variously performed by one or more networked devices such as those of system 100 or network 200, according to different embodiments. For example, one embodiment may include operations of method 400 performed by a device which is to determine whether participation in a transaction is to take place. Another embodiment may include operations of method 400 performed by a device which is to communicate a cost of indemnifying such a transaction.

Method 400 may include, at 405, exchanging attestation information from a node of a network to one or more other nodes of the network. The node may include some or all of the features of device, 110, device 120 and/or platform 300. In an embodiment, the attestation information exchanged at 405 may indicate a trustworthiness level of the node. For example, the exchanging at 405 may include some or all of the features of exchange 1a (or exchange 1b). In an embodiment, a level of trustworthiness of a device may be based on attestation information which describes or otherwise indicates environmental context for the device. Such context may include, for example, the device being at an unknown geographic location, in a known hostile nation/state, identified as stolen, in a poor operational condition and/or the like.

At 410, method 400 may include determining a strength value for the network node based on the attestation information exchanged at 405. By way of illustration and not limitation, a strength value may represent a single metric or a plurality of metrics across multiple dimensions. Such one or more metrics may include, for example, a complexity metric representing network complexity, cyclomatic complexity of software and/or any of various other aspects of system complexity. In an embodiment, a complexity metrics represents a count of a number of cycles, interfaces, sub-structures, code paths, data structures, test points and/or the like for at least some portion of the network.

Alternatively or in addition, a strength value may be calculated based on an immutability metric representing or otherwise indicating a susceptibility of node hardware and/or software to modification. For example, a system of weighted classification may associate immutability metric values to different types of system elements. In an illustrative scenario according to one embodiment, immutability weights of between 0 and 0.0999 may be variously assigned for weakly immutable types of elements such as unprotected RAM and mechanisms providing open network access. By contrast, higher immutability weights—e.g. between 0.2 and 0.2999—may be variously assigned for moderately immutable types of elements, such as FPGAs, PRAMs and/or SEs. Still higher immutability weights—e.g. between 0.9 and 0.999—may be variously assigned for strongly immutable types of elements such as fixed configuration silicon, circuitry, etc. The particular metric values in the above scenario may vary according to implementation-specific details, and are not limiting on certain embodiments.

In an embodiment, a metric representing path protection and/or profile protection (referred to herein as a path/profile metric) may also be a basis for evaluating a strength function. A path protection metric may represent a level or protection provided to one or more communication paths between network nodes. Path protection may take into consideration the distance between connected network components and/or an expected level of electro-magnetic interference (EMI) of the path. A profile protection metric may account for the existence and strength of any proof-of-correctness mechanisms available for assuring correct execution of the trans action.

The particular valuation of some or all such metrics may be according to an a priori scheme which, for example, depends upon the implementation-specific details of the network in question. Although certain embodiments are not limited in this regard, some or all such metrics may be variously normalized each to a respective zero-to-one scale. For example, a strength value N for a particular node may, in one embodiment, be computed at 410 as follows:

N=C*I*P (1)

where a complexity metric (C), immutability metric (I) and path/profile metric (P) of equation (1) are each normalized within a range between 0 to 1. In an embodiment, an N value for a node may be stored within a trusted memory by a manufacturer—e.g. for immutability post manufacturing. Alternatively or in addition, the node's respective C, I and P metric values may be stored in trusted memory for underwriter agents to inspect for generating such an N value.

In an embodiment, a node which is to be available to serve as an underwriter agent may receive, compute or otherwise determine one or more composite scores each for a respective network node—e.g. where such a composite score is calculated according to the following:

CS_{N}=Σᵢ₌₁ⁿ(CSᵢ*N)(n+1)⁻¹ (2)

Equation (2) is an example of one techniques for calculating a composite score CSN for a given node which has a strength value N, such as that according to equation (1). The composite score CSN may represent a combination respective strength scores of the node itself (as a stand-alone platform) and of sub-network nodes which are below that node. In an embodiment, various nodes each correspond to a respective strength-of-function score and a respective composite score. The CS of a child node may be reported to a parent node for calculation of the composite score for the sub-network which is underneath (and which may include) that parent node.

In equation (2), the composite score CSi for a given node i may be determined based on a similar calculation according to equation (2)—e.g. the calculation for node i and those sub-network nodes which are under that node i. Accordingly, equation (2) may be applied recursively to variously calculate composite score for higher nodes in a network hierarchy. The composite score for some node in a lowest level of such a hierarchy (e.g. a “leaf node) may be equal to—or nearly equal to—the strength-of function value for that node. Such strength scores and/or composite scores may be stored by the node as actuarial data to be available for subsequent use in calculating indemnification information for a given transaction.

For example, method 400 may include, at 415, detecting an indication of a transaction—e.g. at a network node which is to offer indemnification for the transaction. The indication detected at 415 may include, for example, a request received from a network node which is to determine whether participation in the transaction is to take place. The network node may request a cost for such indemnification and/or a level of indemnification to be provided in the event of transaction failure, for example.

In response to detecting the indication of the transaction at 415, method 400 may automatically determine, at 420, an indemnification value representing a cost for, or level of, an indemnification for the transaction. By way of illustration and not limitation, a node which is to serve as an underwriter agent may estimate a probability P for failure of a transaction Tx—e.g. a failure due to improper function of the computing resources—by combining the respective composite scores for computing environments' which are under consideration for participating in the transaction. For example, such a probability may be calculated based on respective composite scores CS_{dev1}, CS_{dev2} according to the following:

P(Tx)=CS_{dev1}*CS_{dev2} (3)

Based on calculations such as those in equation (3), the underwriter agent may compute one or mode indemnification risk (IR) values each based on a respective transaction value and transaction failure (or success) probability value. For example, the underwriter may perform one or both of the following:

IR_{dev1}=P(Tx)*Vtx_{dev1} (4a)

IR_{dev2}=P(Tx)*Vtx_{dev2} (4b)

where IR_{dev1} represents the cost of indemnification for a first device, IR_{dev2} represents the cost of indemnification for a second device, Vtx_{dev1} represents the value of the transaction to the first device, and Vtx_{dev2} represents the value of the transaction to the second device.

In an embodiment, computation of transactional risk may be further refined by taking into account the percent of computations for a transaction which occur at a particular node. The percent of computation at a particular node can be estimated using a distributed transaction processing scheduler (DTPS), or other scheduler logic—e.g. where the scheduler optimizes for attack risk in addition to traditional considerations such as CPU speed, power, network latency and the like. In an embodiment, calculation of indemnification risk to account for node computation percentage may be according to the following:

IR_{dev1}=P(Tx)*Vtx_{dev1}*(Timeₜₒₜₐₗ/Time_{dev1}) (4a)

where Timeₜₒₜₐₗ represents a total computation time of the transaction across a plurality of nodes including the first node, and where Time_{dev1} represents that portion of the total computation time for computations performed by the first node.

In an embodiment, method 400 includes, at 425, exchanging the indemnification value at 420 between the node which the determined the indemnification value and the node for which the strength value is determined at 410. Based on the exchanging at 425, the node which receives the indemnification value may determine, at 430, whether to participate in the transaction. Where it is determined at 430 that the node is to participate in the transaction—e.g. including the node determining to agree to an offer of an indemnification policy—method 400 may include, at 435, the node subsequently evaluating whether a failure of the transaction has been indicated. In response to detecting a failure of the transaction at 435, method 400 may include, at 440, the node signaling for authorization of indemnity under the policy covering the transaction.

A network or sub-network thereof may subject to change during operation of the network—e.g. where one or more nodes may be variously added to or removed from the network before or during a transaction. In an embodiment, the network may provide for the strength scores (or composite scores) of network nodes to be updated to reflect such a change in network topology. For example, one of more updates to such scores may be distributed through the network in response to the changed topology, prior to or even during such updated scores being needed for a specific transaction. Hence, the actuarial model may be updated dynamically to fine tune risk exposure by the underwriter even for transactions currently executing.

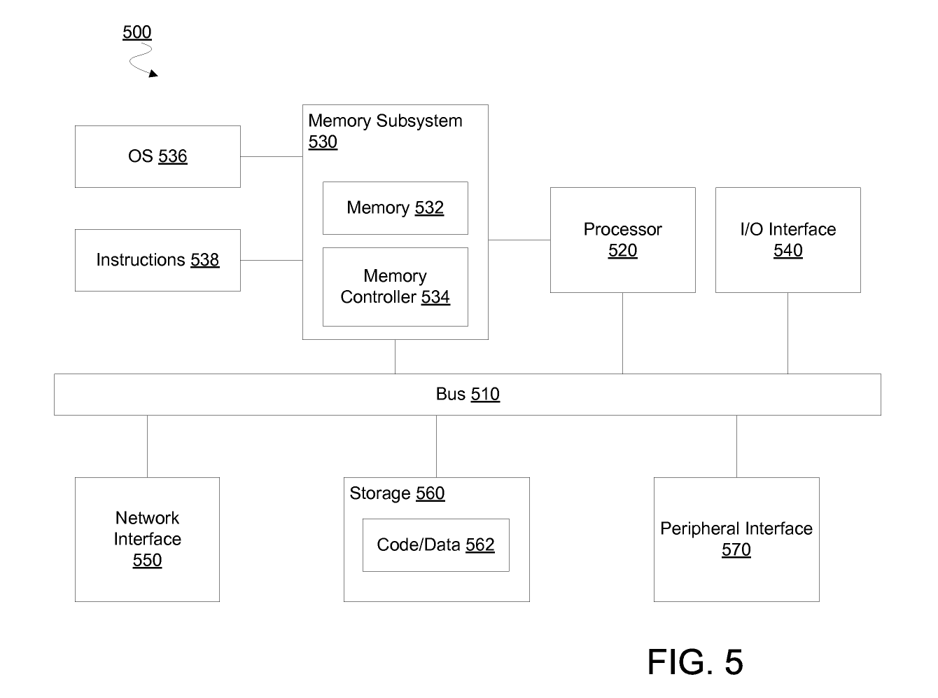

FIG. 5 is a block diagram of an embodiment of a computing system with which transaction indemnification may be implemented. System 500 represents a computing device in accordance with any embodiment described herein, and may be a laptop computer, a desktop computer, a server, a gaming or entertainment control system, a scanner, copier, printer, or other electronic device. System 500 may include processor 520, which provides processing, operation management, and execution of instructions for system 500. Processor 520 may include any type of microprocessor, central processing unit (CPU), processing core, or other processing hardware to provide processing for system 500. Processor 520 controls the overall operation of system 500, and may be or include, one or more programmable general-purpose or special-purpose microprocessors, digital signal processors (DSPs), programmable controllers, application specific integrated circuits (ASICs), programmable logic devices (PLDs), or the like, or a combination of such devices.

Memory subsystem 530 represents the main memory of system 500, and provides temporary storage for code to be executed by processor 520, or data values to be used in executing a routine. Memory subsystem 530 may include one or more memory devices such as read-only memory (ROM), flash memory, one or more varieties of random access memory (RAM), or other memory devices, or a combination of such devices. Memory subsystem 530 stores and hosts, among other things, operating system (OS) 536 to provide a software platform for execution of instructions in system 500. Additionally, other instructions 538 are stored and executed from memory subsystem 530 to provide the logic and the processing of system 500. OS 536 and instructions 538 are executed by processor 520. Memory subsystem 530 may include memory device 532 where it stores data, instructions, programs, or other items. In one embodiment, memory subsystem includes memory controller 534 to provide access to memory device 532.

Processor 520 and memory subsystem 530 are coupled to bus/bus system 510. Bus 510 is an abstraction that represents any one or more separate physical buses, communication lines/interfaces, and/or point-to-point connections, connected by appropriate bridges, adapters, and/or controllers. Therefore, bus 510 may include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 510 may also correspond to interfaces in network interface 550.

System 500 may also include one or more input/output (I/O) interface(s) 540, network interface 550, one or more internal mass storage device(s) 560, and peripheral interface 570 coupled to bus 510. I/O interface 540 may include one or more interface components through which a user interacts with system 500 (e.g., video, audio, and/or alphanumeric interfacing). Network interface 550 provides system 500 the ability to communicate with remote devices (e.g., servers, other computing devices) over one or more networks. Network interface 550 may include an Ethernet adapter, wireless interconnection components, USB (universal serial bus), or other wired or wireless standards-based or proprietary interfaces.

Storage 560 may be or include any conventional medium for storing large amounts of data in a nonvolatile manner, such as one or more magnetic, solid state, or optical based disks, or a combination. Storage 560 holds code or instructions and data 562 in a persistent state (i.e., the value is retained despite interruption of power to system 500). Storage 560 may be generically considered to be a “memory,” although memory 530 is the executing or operating memory to provide instructions to processor 520. Whereas storage 560 is nonvolatile, memory 530 may include volatile memory (i.e., the value or state of the data is indeterminate if power is interrupted to system 500).

Peripheral interface 570 may include any hardware interface not specifically mentioned above. Peripherals refer generally to devices that connect dependently to system 500. A dependent connection is one where system 500 provides the software and/or hardware platform on which operation executes, and with which a user interacts.

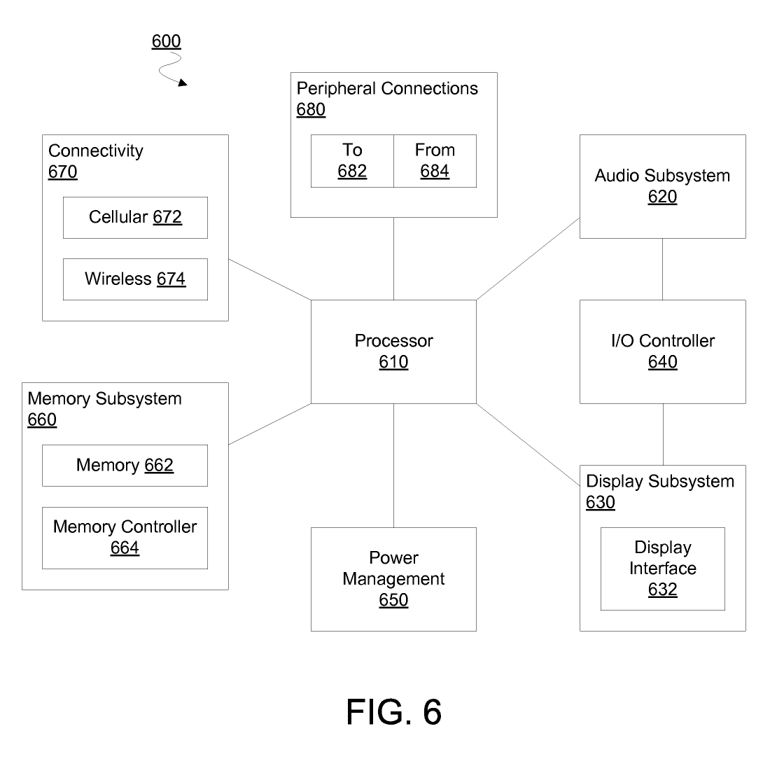

FIG. 6 is a block diagram of an embodiment of a mobile device with which transaction indemnification may be implemented. Device 600 represents a mobile computing device, such as a computing tablet, a mobile phone or smartphone, a wireless-enabled e-reader, or other mobile device. It will be understood that certain of the components are shown generally, and not all components of such a device are shown in device 600.

Device 600 may include processor 610, which performs the primary processing operations of device 600. Processor 610 may include one or more physical devices, such as microprocessors, application processors, microcontrollers, programmable logic devices, or other processing means. The processing operations performed by processor 610 include the execution of an operating platform or operating system on which applications and/or device functions are executed. The processing operations include operations related to I/O (input/output) with a human user or with other devices, operations related to power management, and/or operations related to connecting device 600 to another device. The processing operations may also include operations related to audio I/O and/or display I/O.

In one embodiment, device 600 includes audio subsystem 620, which represents hardware (e.g., audio hardware and audio circuits) and software (e.g., drivers, codecs) components associated with providing audio functions to the computing device. Audio functions may include speaker and/or headphone output, as well as microphone input. Devices for such functions may be integrated into device 600, or connected to device 600. In one embodiment, a user interacts with device 600 by providing audio commands that are received and processed by processor 610.

Display subsystem 630 represents hardware (e.g., display devices) and software (e.g., drivers) components that provide a visual and/or tactile display for a user to interact with the computing device. Display subsystem 630 may include display interface 632, which may include the particular screen or hardware device used to provide a display to a user. In one embodiment, display interface 632 includes logic separate from processor 610 to perform at least some processing related to the display. In one embodiment, display subsystem 630 includes a touchscreen device that provides both output and input to a user.

I/O controller 640 represents hardware devices and software components related to interaction with a user. I/O controller 640 may operate to manage hardware that is part of audio subsystem 620 and/or display subsystem 630. Additionally, I/O controller 640 illustrates a connection point for additional devices that connect to device 600 through which a user might interact with the system. For example, devices that may be attached to device 600 might include microphone devices, speaker or stereo systems, video systems or other display device, keyboard or keypad devices, or other I/O devices for use with specific applications such as card readers or other devices.

As mentioned above, I/O controller 640 may interact with audio subsystem 620 and/or display subsystem 630. For example, input through a microphone or other audio device may provide input or commands for one or more applications or functions of device 600. Additionally, audio output may be provided instead of or in addition to display output. In another example, if display subsystem includes a touchscreen, the display device also acts as an input device, which may be at least partially managed by I/O controller 640. There may also be additional buttons or switches on device 600 to provide I/O functions managed by I/O controller 640.

In one embodiment, I/O controller 640 manages devices such as accelerometers, cameras, light sensors or other environmental sensors, gyroscopes, global positioning system (GPS), or other hardware that may be included in device 600. The input may be part of direct user interaction, as well as providing environmental input to the system to influence its operations (such as filtering for noise, adjusting displays for brightness detection, applying a flash for a camera, or other features).

In one embodiment, device 600 includes power management 650 that manages battery power usage, charging of the battery, and features related to power saving operation. Memory subsystem 660 may include memory device(s) 662 for storing information in device 600. Memory subsystem 660 may include nonvolatile (state does not change if power to the memory device is interrupted) and/or volatile (state is indeterminate if power to the memory device is interrupted) memory devices. Memory 660 may store application data, user data, music, photos, documents, or other data, as well as system data (whether long-term or temporary) related to the execution of the applications and functions of system 600.

In one embodiment, memory subsystem 660 includes memory controller 664 (which could also be considered part of the control of system 600, and could potentially be considered part of processor 610). Memory controller 664 to access memory 662.

Connectivity 670 may include hardware devices (e.g., wireless and/or wired connectors and communication hardware) and software components (e.g., drivers, protocol stacks) to enable device 600 to communicate with external devices. The device could be separate devices, such as other computing devices, wireless access points or base stations, as well as peripherals such as headsets, printers, or other devices.

Connectivity 670 may include multiple different types of connectivity. To generalize, device 600 is illustrated with cellular connectivity 672 and wireless connectivity 674. Cellular connectivity 672 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 674 refers to wireless connectivity that is not cellular, and may include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 680 include hardware interfaces and connectors, as well as software components (e.g., drivers, protocol stacks) to make peripheral connections. It will be understood that device 600 could both be a peripheral device (“to” 682) to other computing devices, as well as have peripheral devices (“from” 684) connected to it. Device 600 commonly has a “docking” connector to connect to other computing devices for purposes such as managing (e.g., downloading and/or uploading, changing, synchronizing) content on device 600. Additionally, a docking connector may allow device 600 to connect to certain peripherals that allow device 600 to control content output, for example, to audiovisual or other systems.

In addition to a proprietary docking connector or other proprietary connection hardware, device 600 may make peripheral connections 680 via common or standards-based connectors. Common types may include a Universal Serial Bus (USB) connector (which may include any of a number of different hardware interfaces), DisplayPort including MiniDisplayPort (MDP), High Definition Multimedia Interface (HDMI), Firewire, or other type.

In one implementation, a method at a computer platform comprises determining a first strength value for a first network node coupled to the computer platform, wherein the first strength value is based on first attestation information from the first network node, wherein the first attestation information indicates a trustworthiness level of the first network node. The method further comprises performing, with underwriter logic of the computer platform, detecting an indication of a transaction, in response to detecting the indication of the transaction, automatically determining based on the first strength value a first indemnification value representing a cost of an indemnification for the transaction, and sending the first indemnification value to the first node, wherein the first node performs a determination, based on the first indemnification value, of whether a participation in the transaction is to take place. The method further comprises executing a general purpose operating system of the computer platform, wherein access to the underwriter logic by the general purpose operating system is restricted.

In an embodiment, the first attestation information is received from attestation logic of the first network node, wherein access to the attestation logic by a general purpose operating system of the first network node is restricted. In another embodiment, the underwriter logic comprises a trusted execution environment. In another embodiment, automatically determining the first indemnification value comprises determining a probability of a failure of the transaction. In another embodiment, automatically determining the first indemnification value further comprises determining a value of a completion of the transaction. In another embodiment, automatically determining the first indemnification value is further based on second attestation information which indicates a trustworthiness level of a second network node. In another embodiment, the method further comprises calculating the first strength value based on a complexity metric. In another embodiment, the method further comprises calculating the first strength value based on an immutability metric. In another embodiment, the method further comprises calculating the first strength value based on a path protection metric. In another embodiment, the method further comprises calculating the first strength value based on a profile protection metric. In another embodiment, the underwriter logic comprises a hardware security module. In another embodiment, the underwriter logic comprises a trusted platform module. In another embodiment, the underwriter logic comprises circuitry to provide a security management mode of software execution.

In another implementation, a computer platform comprises a memory to store a first strength value for a first network node coupled to the computer platform, the first strength value based on first attestation information from attestation logic of the first network node, wherein access to the attestation logic by a general purpose operating system of the first network node is restricted, wherein the first attestation information indicates a trustworthiness level of the first network node. The computer platform further comprises underwriter logic to detect an indication of a transaction and, in response to detection of the indication of the transaction, to automatically determine based on the first strength value a first indemnification value to represent a cost of an indemnification for the transaction, the underwriter logic further to send the first indemnification value to the first node, wherein the first node performs a determination, based on the first indemnification value, of whether a participation in the transaction is to take place.

In an embodiment, the first attestation information is received from attestation logic of the first network node, wherein access to the attestation logic by a general purpose operating system of the first network node is restricted. In another embodiment, the underwriter logic comprises a trusted execution environment. In another embodiment, the underwriter logic comprises a hardware security module. In another embodiment, the underwriter logic comprises a trusted platform module. In another embodiment, the underwriter logic comprises circuitry to provide a security management mode of software execution. In another embodiment, the underwriter logic to automatically determine the first indemnification value comprises the underwriter logic to determine a probability of a failure of the transaction. In another embodiment, the underwriter logic to automatically determine the first indemnification value further comprises the underwriter logic to determine a value of a completion of the transaction. In another embodiment, underwriter logic is to automatically determine the first indemnification value further based on second attestation information which indicates a trustworthiness level of a second network node. In another embodiment, the underwriter logic is to calculate the first strength value based on a complexity metric. In another embodiment, the underwriter logic is to calculate the first strength value based on an immutability metric. In another embodiment, the underwriter logic is to calculate the first strength value based on a path protection metric. In another embodiment, the underwriter logic is to calculate the first strength value based on a profile protection metric.

In another implementation, one or more computer-readable storage media have stored thereon instructions which, when executed by one or more processing units, cause the one or more processing units to perform a method at a computer platform. The method comprises determining a first strength value for a first network node coupled to the computer platform, wherein the first strength value is based on first attestation information from the first network node, wherein the first attestation information indicates a trustworthiness level of the first network node. The method further comprises performing, with underwriter logic of the computer platform, detecting an indication of a transaction, in response to detecting the indication of the transaction, automatically determining based on the first strength value a first indemnification value representing a cost of an indemnification for the transaction, and sending the first indemnification value to the first node, wherein the first node performs a determination, based on the first indemnification value, of whether a participation in the transaction is to take place. The method further comprises executing a general purpose operating system of the computer platform, wherein access to the underwriter logic by the general purpose operating system is restricted.

In an embodiment, the first attestation information is received from attestation logic of the first network node, wherein access to the attestation logic by a general purpose operating system of the first network node is restricted. In another embodiment, the underwriter logic comprises a trusted execution environment. In another embodiment, automatically determining the first indemnification value comprises determining a probability of a failure of the transaction. In another embodiment, automatically determining the first indemnification value further comprises determining a value of a completion of the transaction. In another embodiment, automatically determining the first indemnification value is further based on second attestation information which indicates a trustworthiness level of a second network node. In another embodiment, the method further comprises calculating the first strength value based on a complexity metric. In another embodiment, the method further comprises calculating the first strength value based on an immutability metric. In another embodiment, the method further comprises calculating the first strength value based on a path protection metric. In another embodiment, the method further comprises calculating the first strength value based on a profile protection metric. In another embodiment, the underwriter logic comprises a hardware security module. In another embodiment, the underwriter logic comprises a trusted platform module. In another embodiment, the underwriter logic comprises circuitry to provide a security management mode of software execution.

In another implementation, a system comprises a first computer platform comprising attestation logic to send from the first computer platform first attestation information to indicate a trustworthiness level of first computer platform, and indemnification logic to receive a first indemnification value representing a cost of an indemnification for a first transaction, the indemnification logic further to automatically determine, based on the first indemnification value, whether a participation in the first transaction is to take place. The first computer platform further comprises first processor logic to execute a general purpose operating system, wherein access to the attestation logic by the general purpose operating system is restricted. The system further comprises a second computer platform comprising a memory to store a first strength value for the first computer platform, the first strength value based on the first attestation information from the first computer platform, and underwriter logic to detect an indication of the first transaction and, in response, to automatically determine the first indemnification value based on the first strength value, the underwriter logic further to send the first indemnification value to the first computer platform.

In an embodiment, the first attestation information is received from attestation logic of the first network node, wherein access to the attestation logic by a general purpose operating system of the first network node is restricted. In another embodiment, the underwriter logic comprises a trusted execution environment. In another embodiment, the underwriter logic comprises a hardware security module. In another embodiment, the underwriter logic comprises a trusted platform module. In another embodiment, the underwriter logic comprises circuitry to provide a security management mode of software execution. In another embodiment, the underwriter logic to automatically determine the first indemnification value comprises the underwriter logic to determine a probability of a failure of the transaction. In another embodiment, the underwriter logic to automatically determine the first indemnification value further comprises the underwriter logic to determine a value of a completion of the transaction. In another embodiment, the underwriter logic to automatically determine the first indemnification value further based on second attestation information which indicates a trustworthiness level of a second network node. In another embodiment, the underwriter logic to calculate the first strength value based on a complexity metric. In another embodiment, the underwriter logic to calculate the first strength value based on an immutability metric. In another embodiment, the underwriter logic to calculate the first strength value based on a path protection metric. In another embodiment, the underwriter logic to calculate the first strength value based on a profile protection metric.

In another implementation, a computer platform comprises attestation logic to send first attestation information to one or more network nodes coupled to the computer platform, the first attestation information to indicate a trustworthiness level of computer platform, wherein, based on the first attestation information, the one or more network nodes store a first strength value for the computer network. The computer platform further comprises indemnification logic to receive from the one or more network nodes a first indemnification value based on the first strength value, wherein the first indemnification value is received in response to an indication of a first transaction, the first indemnification value representing a cost of an indemnification for the first transaction, the indemnification logic further to automatically determine whether the computer platform is to participate in the first transaction based on the first indemnification value. The computer platform includes processor logic to execute a general purpose operating system, wherein access to the attestation logic by the general purpose operating system is restricted.

In another implementation, a method at a computer platform comprises, with attestation logic of the computer platform, sending first attestation information from the computer platform to one or more network nodes, the first attestation information indicating a trustworthiness level of computer platform, wherein, based on the first attestation information, the one or more network nodes of the network store a first strength value for the computer network. The method further comprises receiving from the one or more network nodes a first indemnification value based on the first strength value, wherein the first indemnification value is received in response to an indication of a first transaction, the first indemnification value representing a cost of an indemnification for the first transaction. The method further comprises automatically determining whether the computer platform is to participate in the first transaction based on the first indemnification value, executing a general purpose operating system, wherein access to the attestation logic by the general purpose operating system is restricted.

In another implementation, one or more computer-readable storage media have stored thereon instructions which, when executed by one or more processing units, cause the one or more processing units to perform a method at a computer platform. The method comprises, with attestation logic of the computer platform, sending first attestation information from the computer platform to one or more network nodes, the first attestation information indicating a trustworthiness level of computer platform, wherein, based on the first attestation information, the one or more network nodes of the network store a first strength value for the computer network. The method further comprises receiving from the one or more network nodes a first indemnification value based on the first strength value, wherein the first indemnification value is received in response to an indication of a first transaction, the first indemnification value representing a cost of an indemnification for the first transaction. The method further comprises automatically determining whether the computer platform is to participate in the first transaction based on the first indemnification value, and executing a general purpose operating system, wherein access to the attestation logic by the general purpose operating system is restricted.

Techniques and architectures for indemnifying a transaction are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

1-25. (canceled)

26. A method at a computer platform, the method comprising:
determining a first strength value for a first network node coupled to the computer platform, wherein the first strength value is based on first attestation information from the first network node, wherein the first attestation information indicates a trustworthiness level of the first network node; and
with underwriter logic of the computer platform:
detecting an indication of a transaction;
in response to detecting the indication of the transaction, automatically determining based on the first strength value a first indemnification value representing a cost of an indemnification for the transaction; and
sending the first indemnification value to the first node, wherein the first node performs a determination, based on the first indemnification value, of whether a participation in the transaction is to take place; and
executing a general purpose operating system of the computer platform, wherein access to the underwriter logic by the general purpose operating system is restricted.

27. The method of claim 26, wherein the first attestation information is received from attestation logic of the first network node, wherein access to the attestation logic by a general purpose operating system of the first network node is restricted.

28. The method of claim 26, wherein the underwriter logic comprises a trusted execution environment.

29. The method of claim 26, wherein automatically determining the first indemnification value comprises determining a probability of a failure of the transaction.

30. The method of claim 29, wherein automatically determining the first indemnification value further comprises determining a value of a completion of the transaction.

31. The method of claim 26, wherein automatically determining the first indemnification value is further based on second attestation information which indicates a trustworthiness level of a second network node.

32. The method of claim 26, further comprising calculating the first strength value based on a complexity metric.

33. The method of claim 26, further comprising calculating the first strength value based on an immutability metric.

34. A computer platform comprising:
a memory to store a first strength value for a first network node coupled to the computer platform, the first strength value based on first attestation information from attestation logic of the first network node, wherein access to the attestation logic by a general purpose operating system of the first network node is restricted, wherein the first attestation information indicates a trustworthiness level of the first network node; and
underwriter logic to detect an indication of a transaction and, in response to detection of the indication of the transaction, to automatically determine based on the first strength value a first indemnification value to represent a cost of an indemnification for the transaction, the underwriter logic further to send the first indemnification value to the first node, wherein the first node performs a determination, based on the first indemnification value, of whether a participation in the transaction is to take place.

35. The computer platform of claim 34, wherein the underwriter logic comprises a trusted execution environment.

36. The computer platform of claim 34, wherein the underwriter logic comprises a hardware security module.

37. The computer platform of claim 34, wherein the underwriter logic comprises a trusted platform module.

38. The computer platform of claim 34, wherein the underwriter logic comprises circuitry to provide a security management mode of software execution.

39. The computer platform of claim 34, wherein the underwriter logic to automatically determine the first indemnification value comprises the underwriter logic to determine a probability of a failure of the transaction.

40. The computer platform of claim 39, wherein the underwriter logic to automatically determine the first indemnification value further comprises the underwriter logic to determine a value of a completion of the transaction.

41. The computer platform of claim 34, wherein the underwriter logic to automatically determine the first indemnification value further based on second attestation information which indicates a trustworthiness level of a second network node.

42. One or more computer-readable storage media having stored thereon instructions which, when executed by one or more processing units, cause the one or more processing units to perform a method at a computer platform, the method comprising:
determining a first strength value for a first network node coupled to the computer platform, wherein the first strength value is based on first attestation information from the first network node, wherein the first attestation information indicates a trustworthiness level of the first network node; and
with underwriter logic of the computer platform:
detecting an indication of a transaction;
in response to detecting the indication of the transaction, automatically determining based on the first strength value a first indemnification value representing a cost of an indemnification for the transaction; and
sending the first indemnification value to the first node, wherein the first node performs a determination, based on the first indemnification value, of whether a participation in the transaction is to take place; and
executing a general purpose operating system of the computer platform, wherein access to the underwriter logic by the general purpose operating system is restricted.

43. The one or more computer-readable storage media of claim 42, wherein the first attestation information is received from attestation logic of the first network node, wherein access to the attestation logic by a general purpose operating system of the first network node is restricted.

44. The one or more computer-readable storage media of claim 42, wherein the underwriter logic comprises a trusted execution environment.

45. The one or more computer-readable storage media of claim 42, wherein automatically determining the first indemnification value comprises determining a probability of a failure of the transaction.

46. The one or more computer-readable storage media of claim 45, wherein automatically determining the first indemnification value further comprises determining a value of a completion of the transaction.

47. The one or more computer-readable storage media of claim 42, wherein automatically determining the first indemnification value is further based on second attestation information which indicates a trustworthiness level of a second network node.

48. A system comprising:
a first computer platform comprising:
attestation logic to send from the first computer platform first attestation information to indicate a trustworthiness level of first computer platform; and
indemnification logic to receive a first indemnification value representing a cost of an indemnification for a first transaction, the indemnification logic further to automatically determine, based on the first indemnification value, whether a participation in the first transaction is to take place; and
first processor logic to execute a general purpose operating system, wherein access to the attestation logic by the general purpose operating system is restricted; and
a second computer platform comprising:
a memory to store a first strength value for the first computer platform, the first strength value based on the first attestation information from the first computer platform; and
underwriter logic to detect an indication of the first transaction and, in response, to automatically determine the first indemnification value based on the first strength value, the underwriter logic further to send the first indemnification value to the first computer platform.

49. The system of claim 48, wherein the underwriter logic comprises a trusted execution environment.

50. The system of claim 48, wherein the underwriter logic to automatically determine the first indemnification value comprises the underwriter logic to determine a probability of a failure of the transaction, a value of a completion of the transaction, and second attestation information which indicates a trustworthiness level of a second network node.
